(19) United States
(12) Patent Application Publication
(10) Pub. No.: US 2007/0275695 A1
(43) Pub. Date: Nov. 29, 2007

(54) METHOD AND APPARATUS FOR FINDING A RENDERING OF A WORK

(75) Inventors: Theodore R. Arneson, Ivanhoe, IL (US); Jon Godston, Chicago, IL (US); Kenneth W. Douros, South Barrington, IL (US); Christopher W. Drackett, Chicago, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/420,372

(22) Filed: May 25, 2006

(51) Int. Cl. H04L 12/58

(52) U.S. Cl. 455/412.1

(57) ABSTRACT

A method and apparatus are for finding a rendering of a work that a user desires to have presented. The method includes performing an internal search within a preferred storage device for one or more acceptable digital renderings of the work, performing a user network search for one or more acceptable digital renderings in one or more devices of a user wireless network (125) that includes the preferred presentation device and the preferred storage device, when the internal search is continued to a next search level, and performing a remote search for one or more acceptable digital renderings in one or more devices of a remote network (150), when the user network search is continued to a next search level. A user wireless device (115) may perform the method.

### FIELD OF THE INVENTION

The present invention relates generally to digital search techniques, and in particular to performing an automatic search for a rendering of a work.

### BACKGROUND

Techniques to search for a desired digital rendering of a work are known, and internet search engines are one example. As wireless mobiles devices proliferate that are capable of presenting renderings of more complex digital works, such as songs and videos, and as user local networks proliferate, users find themselves having to know where to look for a good rendering of a work, which sometimes makes the task frustrating.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts described in this disclosure, and explain various principles and advantages of those embodiments.

FIG. 1, a communications system is shown that includes a user wireless device, a user wireless network, and a remote network, in accordance with certain embodiments of the concepts;

FIGS. 2-4 show a flow chart of a method for finding a rendering of a work that a user desires to have presented, in accordance with some embodiments of the concepts; and . . .

FIG. 5 is a block diagram of a cellular telephone, in accordance with some embodiments of the concepts.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the concepts.

### DETAILED DESCRIPTION

Before describing in detail embodiments that are in accordance with the concepts, it should be observed that the embodiments reside primarily in combinations of method steps and apparatus components related to automatic searching for a digital rendering of a work of art. Accordingly, the apparatus components and method steps have been represented where appropriate by conventional symbols in the drawings, showing only those specific details that are pertinent to understanding the embodiments of the concepts so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

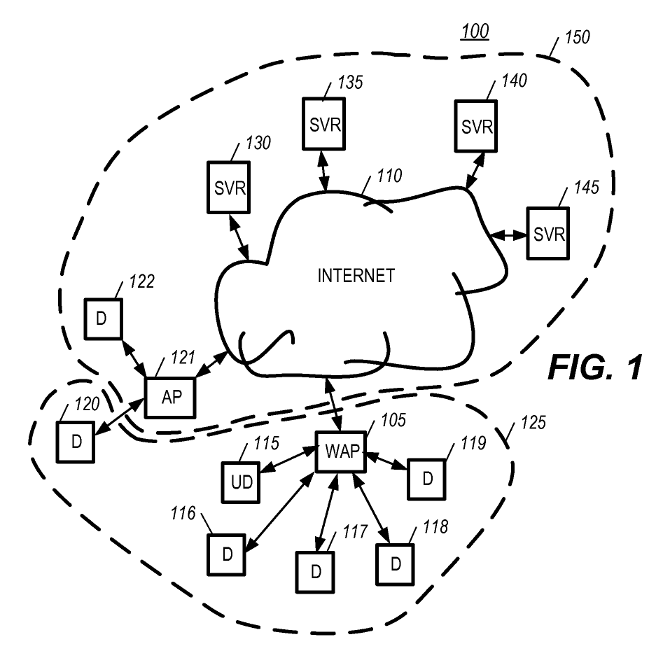

Referring to FIG. 1, a communications system 100 is shown that includes a user wireless device 115, a user wireless network 125, and a remote network 150 that may be wirelessly accessible, in accordance with certain embodiments of the concepts. The user wireless device 115 is capable of being wirelessly connected to other devices 116, 117, 118, 119, 120 and a wireless access point 105 that form at least a portion of the user wireless network 125, but any of these devices may not be connected at all times, nor simultaneously. Not all devices in the user wireless network 125 need be wirelessly connected; some may be connected by wire. One example of such a user wireless network 125 is one in which at least some devices in a residence are coupled by wireless communicating sections that conform to the well known Bluetooth© communication standard published by the 2006 Bluetooth SIG. The devices in such a user wireless network 125 may include, for example a user cellular telephone, a printer, a computer, a television, a sound system, a broadcast radio, and a friend's cellular telephone, all of which are capable of communicating with each other using Bluetooth communication interfaces, either wired or wireless, thereby forming a Bluetooth subnetwork of the user wireless network 125. The user wireless network 125 may also include other devices, as exemplified by device 120, that are coupled to the devices of the aforementioned Bluetooth subnetwork through an internet network 110, or, for example, a cellular network (not shown in FIG. 1), or any other form of communication network. As an example, the user wireless device 115 may at times be connected via the wireless access point 105, at other times may be off, and at other times may be connected via a cellular telephone network. An aspect of the user wireless network 125 may be that the devices in the user wireless network 125 have some digital contents that have been identified as being available to a user of the user wireless device 115 at no charge to the user. An other aspect of the user network may be that it includes any devices that are active on the wireless access point of the user wireless network 125, which may mean that a security code has been provided that allows them to be active on the user wireless network 125. These digital contents are in the form of digital renderings of works, wherein each work may be what would typically be called a work of art or a copyrightable work, such as a performance of a musical composition or part of a musical composition, an image of a picture or part of a picture or graphic, a video or part of a video, etc. In some embodiments, the work may be a digitally streaming rendering of the work, such as a rendering of a live performance.

The remote network 150 also includes devices that include digital contents that are in the form of digital renderings of works, wherein each work is what would typically be called a work of art or a copyrightable work. These works may be available to the user of the user wireless device 115, but may not necessarily be available at no charge to the user, and if they are available at no charge, they may not have been so identified. The remote network 150 is contemplated as being the world wide web, which interconnects a huge quantity of devices using the internet protocol, and many secondary devices coupled to some of the intern devices, as is well known in the art. Included in the devices connected by the remote network are devices that have works that may be made available to the user having one or more user wireless device 115 in a user wireless network 125. Examples of such devices are servers 130, 135, 140, 145, and a remote device 122 coupled through an access point 121. An aspect of the remote network 150 may be that the devices connected by the remote network 150 have some digital contents that have been identified as being available to a user of the user wireless device 115 only at a cost to the user for accessing or presenting them.

In the example shown in FIG. 1, it may be assumed that a user identifies to the user wireless device 115 a work for which the user would like to have a rendering presented on a preferred presentation device of the user wireless network 125, using dialog methods that may employ human interface inputs and outputs of the user wireless device 115, as are well known in the art. The preferred presentation device may be the user wireless device 115, or may be another device in the user network, as may be case when the user wireless device 115 is a cellular telephone or remote control and the user wants a music presentation rendered on a stereo sound system. An aspect of the user wireless network 125 is that it includes the preferred presentation device at least at the time when the rendering is presented. In order to present the rendering, a search is performed for the rendering, as will be described in more detail below. When an acceptable digitized rendering is identified, the digitized rendering is downloaded to a preferred storage device of the user wireless network 125 if the digital rendering is not already stored in the preferred storage device. In some embodiments, the preferred storage device is the same device as either the user wireless device 115 or the preferred presentation device. An example of this situation is when the user wireless device 115 is a cellular telephone with music storage and playing capability, such as a Motorola ROKR© cellular telephone, and the rendering is a digitally rendered song. In other embodiments, the preferred storage device may be a separate device, such as a desktop computer, of the user wireless network 125 that stores a music library, from which a song can be played on a stereo sound system that is also in the user wireless network 125. The preferred storage device may be a different device for some presentations than for others. The user wireless network 125 need not have all of the devices described above as being capable of being in the user network active at any particular time.

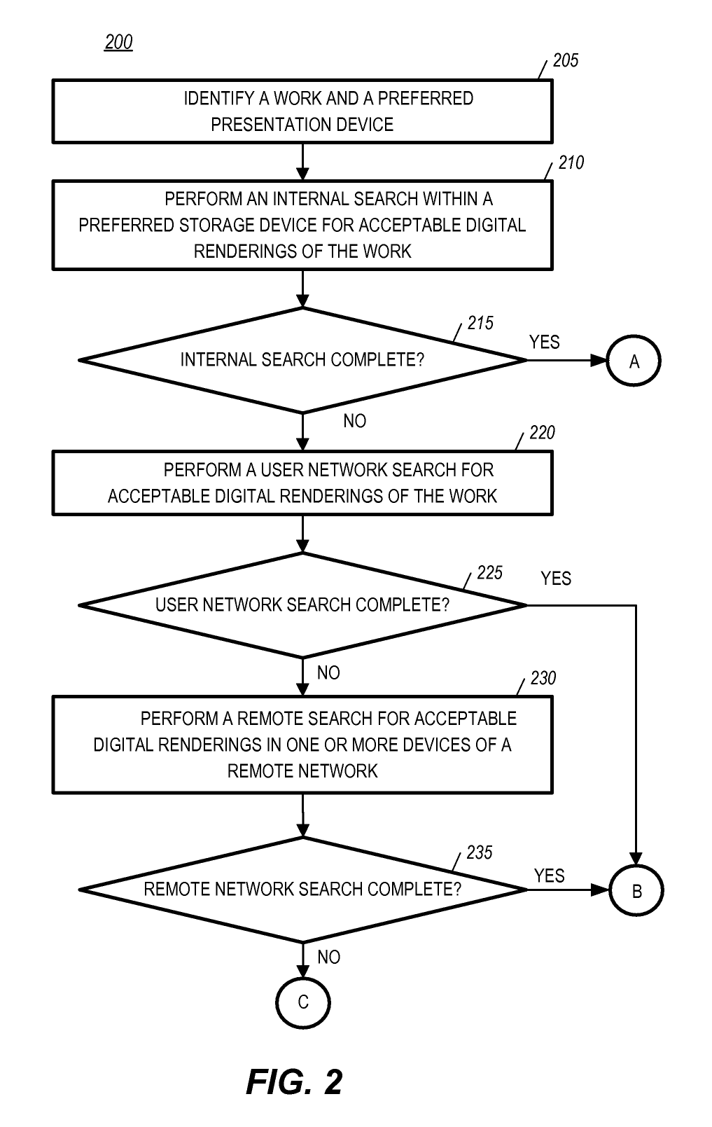

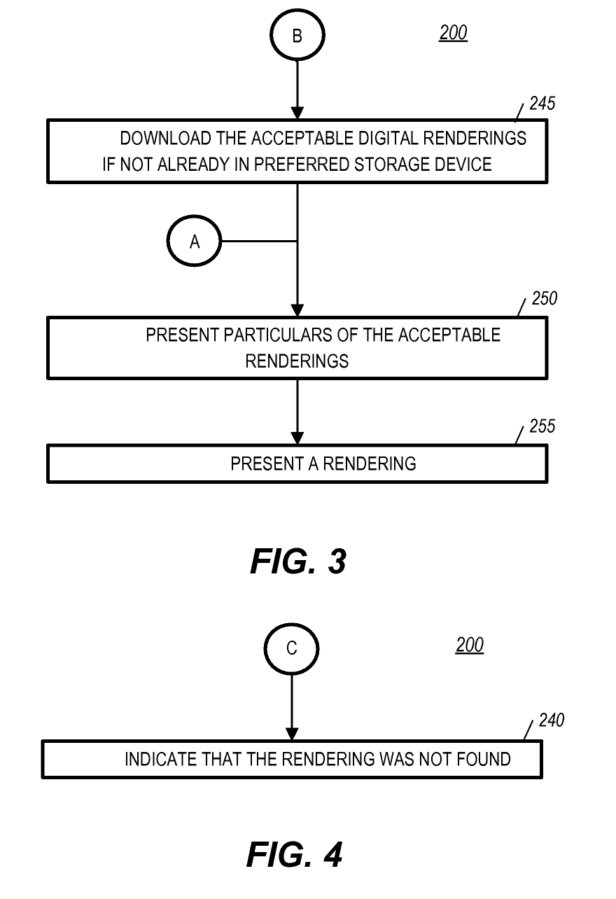

Referring to FIGS. 2-4, a flow chart 200 of a method for finding a rendering of a work that a user desire to have presented is shown, in accordance with certain embodiments of the concepts. At step 205, a user identifies a work and may identify a preferred presentation device for the presentation of a rendering of the work, using the user wireless device 115 to identify these things. In one example, the user identifies the work as being the song “Piano Man” by Billy Joel, and may identify the preferred presentation device as being the user's television and surround sound system. In this example, the user wireless device 115 is a cellular telephone, and the cellular telephone and the television sound system are coupled to the user wireless network 125 by Wi-Fi® wireless networking (which operates according to standards approved by the Wi-Fi Alliance). The user may identify the identity of the work and other information using interactive dialog techniques that are well known in the art, of which one example is filling out fields in an entry form presented on a display, using a keyboard. In the example in which the cellular phone is the user wireless device, the processing of the dialog may be performed in the cellular telephone. In another example, in which the user wireless device 115 is a wireless remote control of the television, the dialog processing may be performed by the television or a cable TV “set top box” or equivalent and the determination of the identified work and preferred presentation device may be processed by a device in the user network that is other than the user wireless device 115. In some embodiments, the preferred presentation device may be a default device of the user wireless network 125, or there may be no preferred presentation device, and the dialog may serve only to identify the work. For example, a default preferred presentation device may only be identified upon a proactive entry by the user, and may remain the same until a next proactive entry.

At step 210, an internal search is performed within a preferred storage device for a digital rendering of the work. The preferred storage device may be a default choice that has been previously identified, or may be one that is, for example, selected by the user during the dialog in which the work is identified. In some embodiments the preferred storage device may be the user wireless device 115. For example, a cellular telephone may store a moderately sized set of songs, such as 400. In other embodiments, the preferred storage device may be a disk drive of a computer that is in the user wireless network 125. The preferred storage device and preferred presentation device may the same device. For example, the user may want to hear a song using a cellular telephone with a headset or earpiece speakers. In this example, the user network may be only the cellular telephone, which is connected (or automatically connectable) to the remote network (world wide web) through the cellular network. In a variation of this situation, the cellular telephone may be the only client device of a Wi-Fi user wireless network 125 having a router that connects the cellular telephone (Wi-Fi equipped) to the world wide web.

The internal search that is performed at step 210 seeks an acceptable digital rendering of the work. An acceptable digital rendering may include any of a narrow or wide range of aspects of the work, as may be further defined during the identification of the work, or at any time before the internal search is started. In the example given above (“Piano Man”), without any other limitation, any rendering that can be presented on the preferred presentation device in any form that is determined by the internal search processing to be acceptable would constitute an acceptable digital rendering. When no preferred presentation device has been identified, then any rendering that could be presented on any device of the user network in an acceptable form may constitute an acceptable digital rendering. Thus, for example, when the preferred presentation device is a cellular telephone without video capabilities, a video of the “Piano Man” may be candidate for audio only presentation. In this example, when the preferred storage device is the cellular telephone, the internal search is performed in the cellular telephone at this step. When the user wireless device is the cellular telephone but the preferred storage device is a disk drive of the user wireless network 125 (perhaps because the cellular telephone can only present a song that is streamed to it by Bluetooth), the internal search is performed in the disk drive. An acceptable digital rendering may therefore be one that at a minimum includes at least some aspect of the work and for which the rendering on the preferred presentation device would be determined (by the internal search process) to be recognizable. Using the above example again, a short (perhaps one second) clip of the “Piano Man” by Billy Joel could meet these minimum criteria. Additional criteria may be defined prior to the internal search, in order to filter the internal search. Such filter criteria may be a set of metadata that is associated with a digital rendering. A non-limiting list of such filter criteria is: a predicted quality of a presentation of the digital rendering on the preferred presentation device, a price of the digital rendering, a size of the digital rendering, a duration of the digital rendering, a format of the digital rendering, and an availability of the digital rendering (e.g., a delay before it can be presented, for any reasons, not the least of which may be bandwidth limitations). Filter criteria other then the minimum criteria may be default criteria, or may be entered for a new search—for example, at the time the work is identified.

The internal search is performed at step 210 until one of a stop searching criterion and a next level search criterion is met, at step 215. The stop searching criterion may be a logical combination of binary values such as NOT [all accessible memory in the preferred storage device has been searched] AND [[a maximum search time] OR [a maximum number of acceptable digital renderings has been found]]. Other binary values may be included. One example of another binary value that may be used in some embodiments for the stop searching criteria is a satisfactory criterion that is determined as a function of metadata values that are associated with the digital rendering. When true, this satisfactory criterion would indicate that a digital rendering has a combination of metadata values that are so good that searching for any more may be canceled. When included, the satisfactory criterion may be included in the strop searching criterion as follows:

NOT [all accessible memory in the preferred storage device has been searched]

AND [[a maximum search time] OR [a maximum number of acceptable digital renderings has been found] OR a satisfactory criterion has been met]]. An example of a satisfactory criterion is a function of one or more metadata values that meet a defined range of values, such as being equal to a defined value or being equal to or greater than a defined value. Some examples of metadata values useful for the satisfactory criterion are: a predicted quality of a presentation of the digital rendering on the preferred presentation device, a price of the digital rendering, a size of the digital rendering, a duration of the digital rendering, a format of the digital rendering, and an availability of the digital rendering (as described above). For the decision step 210, “accessible memory” means the memory in which such a work would normally be stored. Because the search is being performed internally on a device within the user network, the price of any digital rendering should be zero.

When the stop searching criterion is met at step 215, the internal search ends, and selection particulars of the acceptable digital renderings are presented for the user to observe at 250 (FIG. 4). The presentation particulars may be include any metadata about the rendering, such as a predicted quality of a presentation of the digital rendering on the preferred presentation device, a price of the digital rendering, a size of the digital rendering, a duration of the digital rendering, a format of the digital rendering, and an availability of the digital rendering (as described above).

In response to the presentation of the selection particulars at step 250, the user may choose one of the acceptable digital renderings, which is then presented at step 255 on the preferred presentation device.

When the next level searching criterion is met at step 215, then a user network search is performed, at step 220. The next level criterion may be [all accessible memory has been searched in the preferred storage device].

At step 220, the user network search is performed within devices of the user wireless network 125 for a digital rendering of the work. The devices of the user wireless network 125 may be searched in any order, such as a predeterminable order or a random order. The user network search that is performed seeks at least one acceptable digital rendering of the work, wherein “acceptable work” meets the description given above with reference to step 210. The user network search is performed at step 220 until a stop searching criterion or next level search criterion is met, at step 225. The stop searching criterion may be a logical combination of criterion such as described above with reference to step 215, except that [all accessible memory in the preferred storage device has been searched] may be replaced with [all accessible memory in the user wireless network has been searched]. When the stop searching criterion is met at step 225, the user network search ends, and the acceptable digital rendering or renderings are downloaded to the preferred storage device at step 245. Selection particulars of the acceptable digital renderings, including those found (if any) during the internal search, are presented for the user to observe at step 250. The presentation particulars may be as described above with reference to this step. In response to the presentation of the selection particulars at step 250, the user may choose one of the acceptable digital renderings, which is then presented at step 255 on the preferred presentation device. It should be noted that the metadata value “price of the digital rendering” should be zero for user network searches; however, if another metadata value were used, specifically the cost of transporting the digital rendering, then perhaps a transport cost could be incurred for any device of the user network that communicates using bandwidth for which there is a incremental charge.

When the next level search criterion is met at step 225, that is, when all accessible memory has been searched in the user wireless network, then a remote search is performed, at step 230.

At step 230, the remote search is performed within devices of the remote network 150 for a digital rendering of the work. The devices of the remote network 150 may be searched in any order, such as a predeterminable order or a random order, or they may be searched using an external search facility, such as by using the Google® search engine, in an unknown order. The remote search that is performed seeks an acceptable digital rendering of the work, wherein “acceptable work” meets the description given above with reference to step 210. The remote search is performed at step 210 until a stop searching criterion is met at step 235. The stop searching criterion may be a logical combination of criterion such as described above with reference to step 215, except that [all accessible memory in the user network has been searched] may be replaced with [external search autonomously stopped]. When the stop searching criterion is met at step 235, the remote network search ends, and the acceptable digital rendering or renderings are downloaded to the preferred storage device at step 245. The downloading need not be directly to the preferred storage device; it could be downloaded elsewhere in the user wireless network before being downloaded to the preferred storage device.

Selection particulars of the acceptable digital renderings, including those found (if any) during the internal and user network searches, are presented for the user to observe at step 250. The presentation particulars may be as described above with earlier reference to this step. In response to the presentation of the selection particulars at step 250, the user may choose one of the acceptable digital renderings, which is then presented at step 255 on the preferred presentation device.

In the above description, the presentation of the selection particulars is described such that it might be concluded that the particulars for all of the acceptable digital renderings that have found in any of the internal, user network, and remote searches are presented substantially simultaneously, which may be one embodiment. Other embodiments may, for example, present particulars of acceptable digital renderings as they are found. In the above description, an acceptable digital rendering is presented upon user selection. In some embodiments, particularly where a satisfactory digital rendering has been identified, the first digital rendering meeting the criterion may be present automatically.

In one example of the above described method, the user wireless device 115 is activated by the user while the user is at an office location, connected to a cellular telephone network. The user initiates a search for a rendering of a play to present later that day, and identifies the user's TV as the preferred presentation device on which to render the play. The user wireless device 115 is the preferred storage device, so the search starts therein, but it is quickly determined that the play is not located therein. The search then continues in another element of the user wireless network 125, a changer that stores a large plurality of DVD's owned by the user. Not finding a rendering of the play in this changer, the search is expanded to the remote network 150 where several renderings are found. They are presented along with parameters such as resolution and cost, and the user selects one and arranges for it to be played at a particular later time. The user wireless device is in this instance a part of the user wireless network 125 even though it is remotely connected through the wireless access point.

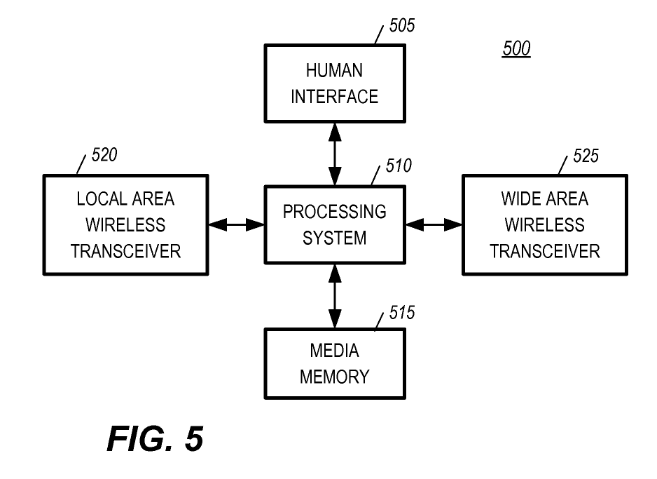

Referring to FIG. 5, a block diagram of a cellular telephone 500 is shown, in accordance with certain embodiments of the concepts. The cellular telephone 500 is just one example of the user wireless device 115 described above. This particular example comprises a processing system 505 that is coupled to a human interface subsystem 510, a media memory 515, a local area network (LAN) transceiver 520, and a cellular system (wide area network—WAN) transceiver. Each of the LAN and WAN transceiver may incorporate specialized processing systems of their own. The human interface 510 may include a video display, a keyboard, indicator lights, and speakers, and a microphone. The media memory 515 in may have a capacity on the order of 1 gigabytes, capable of storing about 200 three or four minute songs, or a smaller duration of video clips.

In this example, the cellular telephone may serve as the device that provides dialog with a user to determine such things as the work that is to be searched for and filter criteria that are used to define an acceptable digital rendering of the work. The cellular telephone 400 may be the preferred presentation device and preferred storage device, either having already been identified as the default device to serve in these capacities, or being identified in these capacities for a search that is being initiated, such as a search for the song “Piano Man” by Billy Joel. When the cellular telephone is the preferred storage device, then when a search is initiated, the internal search will be performed in the media memory 515. If no digital rendering of the song are found in the media memory 400, the user network search would be performed in other devices within the user wireless network, such as a personal computer or a friend's cellular telephone—particularly if the friend's cellular telephone has a compatible LAN transceiving capability.

More generally, the user wireless device in these embodiments comprises at least a human interface and a processing system. The processing system comprises functions for finding a digital rendering of a work identified by means of the human interface, for presentation on a preferred presentation device. The functions include performing an internal search within a preferred storage device for one or more acceptable digital renderings of the work, performing a user network search for one or more acceptable digital renderings in one or more devices of a user wireless network that includes the preferred presentation device and the preferred storage device, when the internal search is continued to a next search level, and performing a remote search for one or more acceptable digital renderings in one or more devices of a remote network, when the user network search is continued to a next search level.

It will be appreciated the processing functions described above with reference to the cellular telephone could, in other embodiments, be performed by a processing system that operates in a device other than the user wireless device, as for example when the user wireless device is a television remote control. In this example, the processing function that runs the search may be in a cable set top box or a personal computer.

The methods and apparatuses described herein provide techniques to find a desired rendering of a work in a more efficient manner than conventional techniques.

It will be appreciated that embodiments of the concepts described herein may be comprised of one or more conventional processors and unique stored program instructions that control the one or more processors to implement, in conjunction with certain non-processor circuits, some, most, or all of the functions of the embodiments of the concepts described herein. The non-processor circuits may include, but are not limited to, a radio receiver, a radio transmitter, signal drivers, clock circuits, power source circuits, and user input devices. As such, these functions may be interpreted as steps of a method to perform a search for a digital rendering of a work. Alternatively, some or all functions could be implemented by a state machine that has no stored program instructions, or in one or more application specific integrated circuits (ASICs), in which each function or some combinations of certain of the functions are implemented as custom logic. Of course, a combination of these approaches could be used. Thus, methods and means for these functions have been described herein. In those situations for which functions of the embodiments of the concepts can be implemented using a processor and stored program instructions, it will be appreciated that one means for implementing such functions is the media that stores the stored program instructions, be it magnetic storage or a signal conveying a file. Further, it is expected that one of ordinary skill, notwithstanding possibly significant effort and many design choices motivated by, for example, available time, current technology, and economic considerations, when guided by the concepts and principles disclosed herein will be readily capable of generating such stored program instructions and ICs with minimal experimentation.

In the foregoing specification, specific embodiments of concepts have been described. These embodiments include the present invention as set forth in the claims below. However, one of ordinary skill in the art appreciates that various modifications and changes to the embodiments can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

1. A method for finding a rendering of a work that a user desires to have presented, comprising:
performing an internal search within a preferred storage device for one or more acceptable digital renderings of the work;
performing a user network search for one or more acceptable digital renderings in one or more devices of a user wireless network that includes the preferred presentation device and the preferred storage device, when the internal search is continued to a next search level; and
performing a remote search for one or more acceptable digital renderings in one or more devices of a remote network, when the user network search is continued to a next search level.

2. The method according to claim 1, further comprising presenting selection particulars of each acceptable digital rendering found in one of the internal, user network, and remote searches on a human interface output of a user wireless device.

3. The method according to claim 2, wherein the selection particulars include one or more of a predicted quality of a presentation of the digital rendering on the preferred presentation device, a price of the digital rendering, a size of the digital rendering, a duration of the digital rendering, a format of the digital rendering, and an availability of the digital rendering.

4. The method according to claim 2, wherein an acceptable digital rendering is one that meets a filter criterion.

5. The method according to claim 4, wherein the filter criterion comprises a function meeting a defined range of values, the function being a function of one or more of a predicted quality of a presentation of the digital rendering on the preferred presentation device, a price of the digital rendering, a size of the digital rendering, a duration of the digital rendering, a format of the digital rendering, and an availability the digital rendering.

6. The method according to claim 2, wherein the preferred presentation device and the user wireless device are one device.

7. The method according to claim 1, wherein the user wireless network comprises at least one device, not owned by the user, which has been identified as having at least one digital rendering that is available for transfer to the preferred presentation device without cost to the user.

8. The method according to claim 1, wherein the user wireless network comprises at least one device not owned by the user, from which the digital rendering of the work is available for transfer to the preferred presentation device without cost to the user.

9. The method according to claim 1, further comprising downloading the digital rendering from a device in the remote network to the preferred presentation device.

10. The method according to claim 1, wherein the preferred presentation device and the preferred storage device are one device.

11. The method according to claim 1, wherein the user wireless network is established using one of a 802.X network and a Bluetooth network.

12. The method according to claim 1, wherein the remote network is an internet protocol network.

13. The method according to claim 1, further comprising determining a set of filter criteria using a dialog that uses one or more human interface inputs and outputs, wherein the at least some aspects of the work are determined by the filter criteria.

14. A user wireless device, comprising:
a human interface; and
a processing system comprising functions for finding a digital rendering of a work identified by means of the human interface, for presentation on a preferred presentation device, the functions including
performing an internal search within a preferred storage device for one or more acceptable digital renderings of the work,
performing a user network search for one or more acceptable digital renderings in one or more devices of a user wireless network that includes the preferred presentation device and the preferred storage device, when the internal search is continued to a next search level, and
performing a remote search for one or more acceptable digital renderings in one or more devices of a remote network, when the user network search is continued to a next search level.

15. The user wireless device according to claim 14, wherein the processor functions further comprise presenting particulars of each digital rendering found in one of the internal, user network, and remote searches on the human interface of the user wireless device as each digital rendering is found.

16. The user wireless device according to claim 15, wherein the processor functions further comprise defining a set of filter criteria that must be met by the digital rendering for the particulars of the digital rendering to be presented.

17. The user wireless device according to claim 15, wherein the preferred presentation device and the user wireless device are one device.

18. The user wireless device according to claim 14, wherein the processor functions further comprise downloading the digital rendering from a device in the remote network to the preferred presentation device.

19. The user wireless device according to claim 14, wherein the preferred presentation device and the preferred storage device are one device.

20. The user wireless device according to claim 14, wherein the processor functions further comprise determining a set of filter criteria using a dialog that uses one or more human interface inputs and outputs, wherein the at least some aspects of the work are determined by the filter criteria.
